(19) United States
(12) Patent Application Publication
(10) Pub. No.: US 2003/0107274 A1
(43) Pub. Date: Jun. 12, 2003

(54) Stepping motor

(75) Inventor: In Ho Lee, Suwon-Shi (KR)

Correspondence Address: DARBY & DARBY P.C., 805 Third Avenue, New York, NY, 10022, US

(73) Assignee: SAMSUNG ELECTRO-MECHANICS CO., LTD., Suwon-Shi (KR)

(21) Appl. No.: 10/123,122

(22) Filed: Apr. 15, 2002

(30) Foreign Application Priority Data
Dec. 6, 2001 (KR) 2001-77015

(51) Int. Cl. H02K 37/00

(52) U.S. Cl. 310/49 R

(57) ABSTRACT

The present invention relates to a stepping motor. The stepping motor comprises: a rotor having a cylindrical magnet with a plurality of N-S poles being radially magnetized and a shaft having one end coupled to the center of the magnet and rotationally supported by bearings; at least one coil wound into the shape of a rim with an air gap from a side of the magnet; and a stator shaped as a cylinder for receiving the coil, the stator having a cylindrical inner pole tooth with a proper diameter, the inner pole tooth being projected from one inner central face of the stator opposedly to the side of the magnet, and a plurality of outer pole teeth extendedly branched at the same interval and opposedly arranged with an air gap from the outer circumferential face of the magnet.

### BACKGROUND OF THE INVENTION

1. Field of the Invention

The present invention relates to a stepping motor for performing rotational movement corresponding to pulse power, in particular, which enables downsizing of the stepping motor while ensuring stable output performance.

2. Description of the Related Art

In general, a stepping motor maintains a very large static torque in the stopped position compared to other motors while being rotated at a given angle without feedback for detecting the position of a shaft and stopping at a considerably high precision rate. Therefore, the stepping motor does not require a separate position-maintaining mechanism such as electromagnetic brake and the rotation speed thereof is proportional to pulse rate, and thus the stepping motor has a driving characteristic that it can be readily controlled.

Due to such characteristics, the stepping motor is generally used in operations for precisely controlling mechanical movement, and in particular, widely used as a driving source of since it can be controlled digitally via pulse.

For example, the stepping motor is used as a driving source for controlling the printing position of a print head, the pen position of an X-Y plotter or the head position of a floppy disk and various disk ROMs. Also, the stepping motor is used for precision control of various electronic instruments such as paper money counter, sewing machine, electric typewriter and facsimile.

FIG. 1 is a schematic sectional view showing a stepping motor of the prior art, and FIG. 2 is a perspective view showing the stepping motor of the prior art. As shown in the drawings, the stepping motor is mainly comprised of a rotor and a stator.

The rotor is constituted of a shaft s and a magnet m. The shaft s functioning as an output end having a predetermined length is inserted into bearings b coupled in central planes of the first and second cover plates c1 and c2 to be supported rotationally in a forward or reverse direction. In the outer circumferential face of one end of the shaft s, is provided the magnet m substantially shaped as a cylinder, which has a configuration that N and S poles are alternately magnetized in the outer circumferential face.

Meanwhile, the magnet m is arranged opposite to the following coils 130 and 230 in the inner circumferential face of the stator with a predetermined air gap therefrom to generate a predetermined amount of electromagnetic force through the interaction.

The stator is mainly comprised of the first and second yokes 110 and 210 which are arranged and coupled colinear, and the coils 130 and 230 are wound in the inner faces of the yokes 110 and 210.

In particular, the first yoke 110 has an inside bobbin 120 and the coil 130 wound around the outer face of the bobbin 120. In the inner face of the rotor opposed to the magnet m, the yoke is alternately arranged to have a shape of tooth-type engagement.

The second yoke 210, as the first yoke 110, is provided in the inner face with a bobbin 220 around which the coil 230 is wound. In the inner face of the foregoing rotor opposed to the magnet m, the yoke is alternately arranged to have a shape of tooth-type engagement.

Meanwhile, the first and second stators 100 and 200, when seen from the drawings, are so configured that the right and left faces are integrally fixed by the first and second cover plates c1 and c2 interposing bearings in the central face for rotationally supporting the shaft s.

In the conventional stepping motor having the configuration as set forth above, when both of the coils 130 and 230 of the first and second stators 100 and 200 are externally applied with current, the coils 130 and 230, the first and second yokes 110 and 210 and the magnetic poles of the magnet m undergo interaction to generate electromagnetic force, thereby causing the rotor having the magnet m and the shaft s to rotate about the first and second stators 100 and 200.

Lately, as the precision instruments are downsized and thin-shaped, the stepping motor mounted to the precision instruments is also required to be slimmed. However, the conventional stepping motor comprises a number of components having diameters different from each other in the outer circumferential face about the shaft s, thereby restricting downsizing.

For example, there is a method for downsizing the conventional stepping motor by reducing the diameters of the magnet m and the coils 130 and 230. In this configuration, however, electromagnetic force of the magnet m and the coils 130 and 230 are lowered also, thereby lowering mutual electromagnetic force by a large margin. Therefore, as the motor is downsized, the output capacity is also lowered thereby restricting downsizing.

### SUMMARY OF THE INVENTION

The present invention has been devised to solve the foregoing problem relates to a stepping motor for performing rotational movement corresponding to pulse power, in particular, in which coils of yokes are arranged axially of a magnet, thereby enabling downsizing of the stepping motor while ensuring stable output performance.

In accordance with an aspect of the invention to obtain the foregoing object, a stepping motor comprises: a rotor having a cylindrical magnet with a plurality of N-S poles being radially magnetized and a shaft having one end coupled to the center of the magnet and rotationally supported by bearings; at least one coil wound into the shape of a rim with an air gap from a side of the magnet; and a stator shaped as a cylinder for receiving the coil, the stator having a cylindrical inner pole tooth with a proper diameter, the inner pole tooth being projected from one inner central face of the stator opposedly to the side of the magnet, and a plurality of outer pole teeth extendedly branched at the same interval and opposedly arranged with an air gap from the outer circumferential face of the magnet.

Preferably, the yoke comprises first and second yokes provided at axially both sides of the magnet, wherein the first and second yokes are opposed to each other.

Preferably, the inner pole tooth and the outer pole teeth are energized into the N or S pole.

Also, preferably, the first and second yokes are fixedly inserted into a cylinder-shaped housing.

In accordance with another aspect of the invention to obtain the foregoing object, a stepping motor comprises: a cylindrical magnet with a plurality of N-S poles being radially magnetized; a shaft having one end coupled to the center of the magnet and rotationally supported by bearings; a pair of coils axially provided at both sides of the magnet, each of the coils being wound into the shape of a rim in the outer circumferential face of a cylinder-shaped bobbin; first and second yokes for receiving the coils therein and arranged concentrically at both sides of the magnet; cylindrical inner pole teeth projected from the inner central faces of the first and second yokes, each of the inner pole teeth having one side opposed to one side of the magnet with a proper interval and energized into N or S pole according to the direction of current applied to each of the coils; outer pole teeth integrally provided in the outer circumferential faces of the first and second yokes, extendedly branched into opposed directions to one another to be opposed with a proper air gap in the outer circumferential face of the magnet, and energized into N or S poles according to the direction of current applied to the coils; and a housing for being fixedly coupled with the outer circumferential edges of the first and second yokes.

### BRIEF DESCRIPTION OF THE DRAWINGS

FIG. 1 is a schematic sectional view showing a stepping motor of the prior art;

FIG. 2 is a perspective view showing a stepping motor of the prior art;

FIG. 3 is a sectional view showing a stepping motor in accordance with the invention;

FIG. 4 is an exploded perspective view showing a stepping motor in accordance with the invention;

FIGS. 5 and 6 are conceptual views showing flux paths in a stepping motor in accordance with the invention; and

FIG. 7 illustrates operations in accordance with the invention.

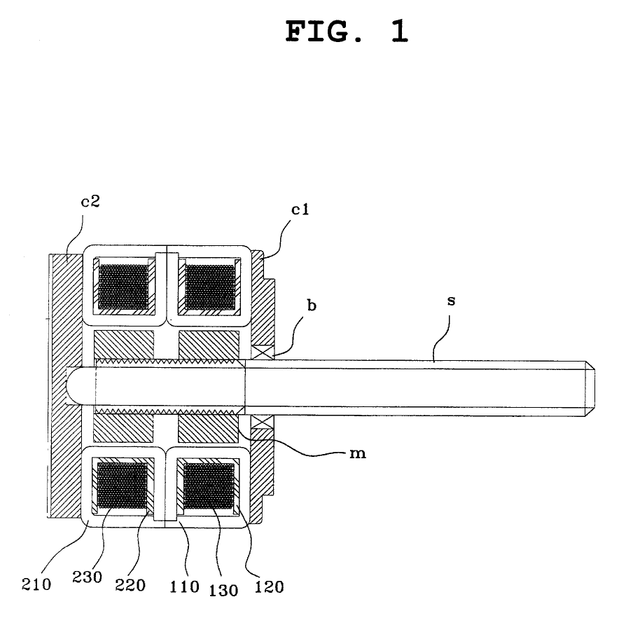

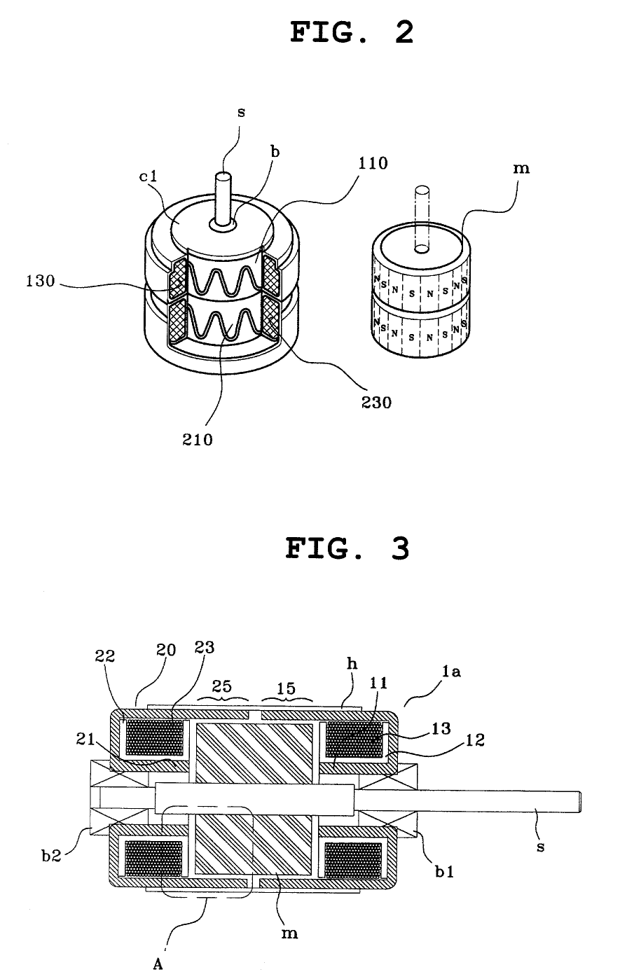

### DETAILED DESCRIPTION OF THE PREFERRED EMBODIMENT

The following detailed description will present a preferred embodiment in reference to the accompanying drawings.

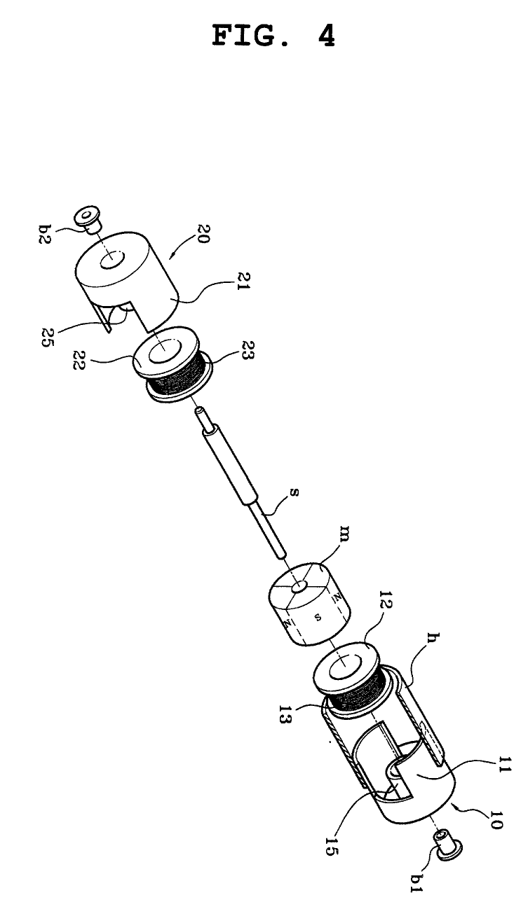

FIG. 3 is a sectional view showing a stepping motor in accordance with the invention, and FIG. 4 is an exploded perspective view showing a stepping motor in accordance with the invention. As shown in the drawings, the stepping motor is mainly comprised of a rotor for driving rotation and a stator for maintaining a fixed state.

The rotor is constituted of a shaft s and a magnet m, in which the shaft s, as shown in FIGS. 3 and 4, has a structure with one end inserted into the center of the first and second yokes 10 and 20 and axially supported by a plurality of bearings b1 and b2 to be rotated in a forward/reverse direction. In the outer circumference of the shaft s, the magnet m having magnetized N or S poles is arranged.

The magnet m has a substantially cylindrical shape and a plurality of N and S poles are alternately magnetized in the outer circumference in a circumferential direction. The magnet m generates electromagnetic force through the interaction with the following coils 13 and 23.

The stator is mainly constituted of the first yoke 10 and the second yoke 20. The first and second yokes 10 and 20 have a substantially cylindrical shape, and as shown in FIG. 3, are arranged concentrically at both sides interposing the magnet m with a predetermined interval of air gap.

The first yoke 10 is shaped as substantially cylindrical, and has teeth-shaped outer pole teeth 11 in the outer circumferential face. The teeth-shaped outer pole teeth 11 surround the outer circumferential face of the magnet m, and have N or S polarity. In the central face inside the outer pole teeth 11, is provided a cylinder-shaped inner pole tooth 15 which is opposed to the side of the magnet m.

The outer pole teeth 11 and the inner pole tooth 15 have a predetermined interval of air gap in respect to the outer circumferential face and side of the magnet m. The outer pole teeth 11 of the invention are energized into the N or S poles, and branched at the same interval of 180 deg. The inner pole tooth 15 is generally shorter than the teeth-shaped outer pole teeth 11, and energized into the N or S pole.

Meanwhile, the first yoke 10 has a rim-shaped bobbin 12 in the inner face or the outer circumferential face of the inner pole tooth 15 and a coil 13 which is wound around the outer circumferential face of the bobbin 12. The outside diameter of the bobbin 12 is slightly smaller than that of the outer pole teeth 11. The diameter of a hole extending through the center of bobbin 12 is slightly larger than that of the inner pole tooth 15.

The first yoke 10 having the foregoing configuration is energized into the N or S pole through the conduction of the coil 13 provided in the inner face of the yoke 10.

The second yoke 20, as the first yoke 10, is provided with a cylinder-shaped inner pole tooth 25 and teeth-shaped outer pole teeth 21. Between the inner pole tooth 25 and the outer pole teeth 21, a rim-shaped bobbin 22 and a coil 23 are provided.

The outer pole teeth 21 of the second yoke 20 are substantially cylindrical, and has the outer circumferential face having N or S polarity in the shaped of surrounding the outer circumferential face of the magnet m. The inner pole tooth 25 is in the central face inside the second yoke 20, and arranged as opposed to the side of the magnet m.

The outer pole teeth 21 and the inner pole tooth 25 have a predetermined interval of air gap in respect to the outer circumferential face and side of the magnet m, and energized through the conduction of the coil 23.

The first yoke 10 and the second yoke 20 are respectively energized into the N or S poles according to the direction of current applied to both of the coils 13 and 23.

In the stepping motor configured as set forth above, the cylindrical first and second yokes 10 and 20 are concentrically arranged with the predetermined air gap at both sides of the magnet m placed therebetween. In the inner faces of the first and second yoke 10 and 20, are respectively provided the rim-shaped bobbins 12 and 22 around which coils 13 and 23 are wound. The first and second yokes 10 and 20 are respectively provided with the outer pole teeth 11 and 21, which are extendedly branched toward each other to surround the magnet m with the predetermined air gap in the outer circumferential face of the magnet m. The outer pole teeth 11 and 21 are branched in plurality to form magnetic poles which are energized into the N or S poles. The cylindrical inner pole teeth 15 and 25 provided in the central faces inside the first and second yokes 10 and 20 have the diameters smaller than those of the outer pole teeth 11 and 21. The lateral ends of the inner pole teeth 15 and 25 are opposed to each other at the sides of the magnet m with the predetermined air gap, and energized into the N or S pole.

In the first and second stators 10 and 20 configured as set forth above, when the coils 13 and 23 are applied with current, the outer pole teeth 11 and 21 and the inner pole teeth 15 and 25 are energized to form flux paths in a region designated with “A” in FIG. 3.

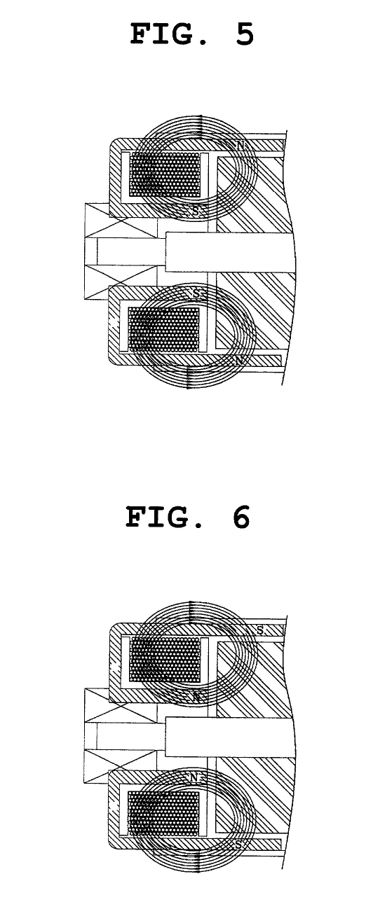

FIGS. 5 and 6 are conceptual views showing flux paths in a stepping motor in accordance with the invention, in which the first and second yokes 10 and 20 generate the flux paths through the conduction of the coils 13 and 23 as shown in the drawings.

Therefore, in the stepping motor having the foregoing configuration, when the coils 13 and 23 of the first and second yokes 10 and 20 are applied with current, the outer pole teeth 11 and 21 and the inner pole teeth 15 and 25 of the first yokes 10 and 20 are energized. Under this condition, the flux paths are generated as shown with full lines due to leakage fluxes of the ends of the poles 15 and 25 opposed to the magnets m. As a result, electromagnetic force is generated between the coils 13 and 23 and the first and second yokes 10 and 20, thereby causing the rotor to rotate about the stator.

Meanwhile, the unexplained reference numerals b1 and b2 designate bearings b1 and b2 which are inserted into the central faces of the first and second yokes 10 and 20. The bearings b1 and b2 axially support the shaft s to be rotated in forward and reverse directions. The reference numeral h designates a cylindrical housing which is coupled to the outer circumferential edges of the first and second yokes 10 and 20 to fix the same.

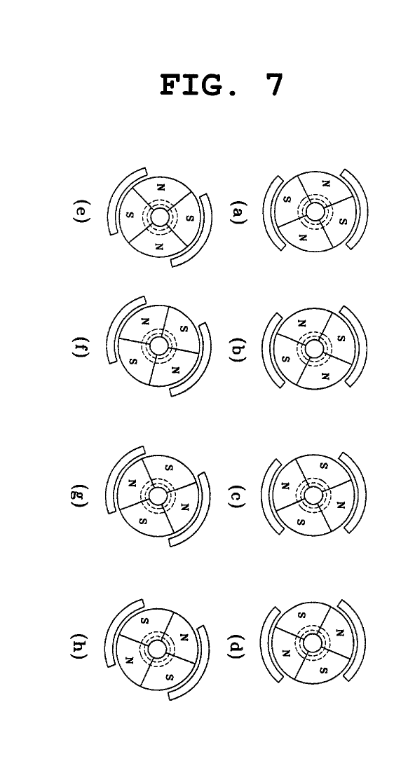

The following description will present the operation of the stepping motor configured as above in accordance to the invention in reference to FIG. 7.

When the coils 13 and 23 are applied with current in one direction in (a) and (e) states, the outer pole teeth 11 of the first yoke 10 are energized into the N pole and the inner pole tooth 15 into the S pole. On the other hand, the outer pole teeth 21 of the second yoke 20 are energized into the N pole and the inner pole tooth 25 into the S pole. The magnet m acting as the rotor is rotated counterclockwise for about 45 deg. to obtain (b) and (f) states.

When the direction of current to the coil 13 of the first yoke 10, the outer pole teeth 11 of the first yoke 10 are energized into the S pole and the inner pole tooth 15 into the N pole, but the outer pole teeth 21 and the inner pole tooth 25 of the second yoke 20 maintain the energized states of the N pole and the S pole. Then, the magnet m as the rotor is rotated counterclockwise for about 45 deg. from the (a) and (e) states to (c) and (g) states.

When the direction of current of the coil 23 applied to the second coil 20 is reversed in the (c) and (g) states, the outer pole teeth 21 of the second yoke 20 are energized into the S pole and the inner pole tooth 25 into the N pole. At this time, the outer pole teeth 11 and the inner pole tooth 15 of the first yoke 10 maintain the energized states of the S pole and the S pole. As a result, the magnet m as the rotor is rotated counterclockwise from the (c) and (g) states for about 45 deg., and shown as (d) and (a) states.

As the conducting directions of the coils 13 and 23 of the first and second yokes 10 and 20 are changed in sequence, the magnet m as the rotor can be rotated for a predetermined angle.

Although the preferred embodiment of the present invention have been disclosed for illustrative purposes, the scope of the invention is not restricted to the embodiment but can be adequately varied in the category of the same spirit. For example, the shape and structure of the each component disclosed in the embodiment of the invention can be modified in implementation.

In the stepping motor of the invention having the configuration and operation as set forth above, the coils are arranged axially at both sides of the magnet while the one ends of the yokes having the coils are opposedly extended in the outer circumferential face of the magnet to form the poles, thereby reducing the entire thickness of the motor while ensuring stable output performance.

In particular, such a configuration further increases the degree of freedom in design due to downsizing of the motor.

What is claimed is:

1. A stepping motor comprising:
a rotor having a cylindrical magnet with a plurality of N-S poles being radially magnetized and a shaft having one end coupled to the center of the magnet and rotationally supported by bearings;
at least one coil wound into the shape of a rim with an air gap from a side of the magnet; and
a stator shaped as a cylinder for receiving the coil, the stator having a cylindrical inner pole tooth with a proper diameter, the inner pole tooth being projected from one inner central face of the stator opposedly to the side of the magnet, and a plurality of outer pole teeth extendedly branched at the same interval and opposedly arranged with an air gap from the outer circumferential face of the magnet.

2. The stepping motor in accordance with claim 1, wherein the yoke comprises first and second yokes provided at axially both sides of the magnet, wherein the first and second yokes are opposed to each other.

3. The stepping motor in accordance with claim 1, wherein the inner pole tooth and the outer pole teeth are energized into the N or S pole.

4. The stepping motor in accordance with claim 2, wherein the first and second yokes are fixedly inserted into a cylinder-shaped housing.

5. A stepping motor comprising:
a cylindrical magnet with a plurality of N-S poles being radially magnetized;
a shaft having one end coupled to the center of the magnet and rotationally supported by bearings;
a pair of coils axially provided at both sides of the magnet, each of the coils being wound into the shape of a rim in the outer circumferential face of a cylinder-shaped bobbin;
first and second yokes for receiving the coils therein and arranged concentrically at both sides of the magnet;
cylindrical inner pole teeth projected from the inner central faces of the first and second yokes, each of the inner pole teeth having one side opposed to one side of the magnet with a proper interval and energized into N or S pole according to the direction of current applied to each of the coils;
outer pole teeth integrally provided in the outer circumferential faces of the first and second yokes, extendedly branched into opposed directions to one another to be opposed with a proper air gap in the outer circumferential face of the magnet, and energized into N or S poles according to the direction of current applied to the coils; and
a housing for being fixedly coupled with the outer circumferential edges of the first and second yokes.
